(19) United States
(12) Patent Application Publication
(10) Pub. No.: US 2023/0244900 A1
(43) Pub. Date: Aug. 3, 2023

(54) Automated Multi-Persona Response Generation

(71) Applicant: Disney Enterprises, Inc., Burbank, CA (US)

(72) Inventors: Douglas A. Fidaleo, Canyon Country, CA (US); James R. Kennedy, Glendale, CA (US); Jon Hayes Snoddy, Pasadena, CA (US); Jeremie A. Papon, Los Angeles, CA (US)

(21) Appl. No.: 17/587,350

(22) Filed: Jan. 28, 2022

(51) Int. Cl. G06N 3/00; G06N 20/00; B25J 11/00; G10L 13/027

(52) U.S. Cl. CPC G06N 3/006; G06N 20/00; B25J 11/0015; B25J 11/001; G10L 13/027

(57) ABSTRACT

A system for performing automated multi-persona response generation includes processing hardware, a display, and a memory storing a software code. The processing hardware executes the software code to receive input data describing an action and identifying a multiple interaction profiles corresponding respectively to multiple participants in the action, obtain the interaction profiles, and simulate execution of the action with respect to each of the participants. The processing hardware is further configured to execute the software code to generate, using the interaction profiles, a respective response to the action for each of the participants to provide multiple responses. In various implementations, one or more of those multiple responses may be used to train additional artificial intelligence (AI) systems, or may be rendered to an output device in the form of one or more of a display, an audio output device, or a robot, for example.

### BACKGROUND

Advances in artificial intelligence have led to the development of a variety of systems providing interfaces that simulate social agents. However, composing dialogue or choreographing actions for execution by a social agent requires an understanding of not only what the social agent should say or do, but also anticipating how a user or interaction participant (hereinafter “participant”) will respond during a particular interaction with the social agent. Given the variability of human language, personality types or “personas,” demographics, and the context in which an interaction takes place, it is infeasible for a human system designer to predict all of the possible responses a participant might make for all but the simplest interactive prompts.

In the existing art, responses to dialogue content for example, are typically tested by directing samples of dialogue to different human subjects, and collecting and analyzing the responses by those subjects. However, such an approach imposes a high resource and time overhead. For example, these existing techniques may require several weeks or more to generate the variety of responses needed by dialogue authors to accurately associate anticipated participant responses with the variety of personas and interaction contexts that are likely to be encountered.

### BRIEF DESCRIPTION OF THE DRAWINGS

FIG. 1 shows an exemplary system for performing automated multi-persona response generation, according to one implementation:

FIG. 2 illustrates an exemplary use case for application of automated multi-persona response generation, according to one implementation;

FIG. 3 illustrates an exemplary use case for application of automated multi-persona response generation, according to another implementation; and

FIG. 4 shows a flowchart presenting an exemplary method for performing automated multi-persona response generation, according to one implementation.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals.

The present application discloses systems and methods for performing automated multi-persona response generation. As used in the present description, the term “response” may refer to language-based communications in the form of speech or text, for example, and in some implementations may include non-verbal expressions. Moreover, the term “non-verbal expression” may refer to vocalizations that are not language-based, i.e., non-verbal vocalizations, as well as to facial expression, physical gestures, actions, and behaviors. Examples of non-verbal vocalizations may include a sigh, a murmur of agreement or disagreement, or a giggle, to name a few.

As used in the present description, the expression “interaction profile” refers to communication habits or traits that are idiosyncratic or otherwise characteristic of a particular individual, of a class of such individuals, or of a fictional character. Thus, an interaction profile of a participant or class of participants may include multiple factors including personality type, traits or persona (e.g., introversion versus extroversion, openness, agreeableness, neuroticism, contentiousness and the like), age, gender, ethnicity, spoken language, dialect, and in some implementations, real or simulated previous interactions of an individual with a social agent. Unless otherwise specified, the particular traits of interest to a particular application are chosen to meet the needs of that application.

Furthermore, as used in the present application, the term “social agent” refers to a non-human communicative entity rendered in hardware and software that is designed for communication with one or more participants, which may be human beings, other interactive machines instantiating non-human social agents or fictional characters, or a group including one or more human beings and one or more other interactive machines. In some use cases, a social agent may be instantiated as a virtual character rendered on a display and appearing to watch and listen to an interaction participant in order to have a conversation with the interaction participant. In other use cases, a social agent may take the form of a machine, such as a robot for example, appearing to watch and listen to an interaction participant in order to converse with the interaction participant. Alternatively, a social agent may be implemented as a mobile device software application providing an automated voice response (AVR) system, or an interactive voice response (IVR) system, for example.

In addition, the expression “context for an action” can refer to activities engaged in by a participant previous to, subsequent to, or concurrently with an action being performed, the goal or motivation of the participant, environmental factors such as weather and location, and the subject matter of a communication with the participant. It is also noted that, as used in the present application, the terms “automation,” “automated,” and “automating” refer to systems and processes that do not require the participation of a human administrator. Although in some implementations the multi-persona responses generated by the systems and methods disclosed herein may be reviewed or even modified by a human editor or dialogue author, that human involvement is optional. Thus, the methods described in the present application may be performed under the control of hardware processing components of the disclosed systems.

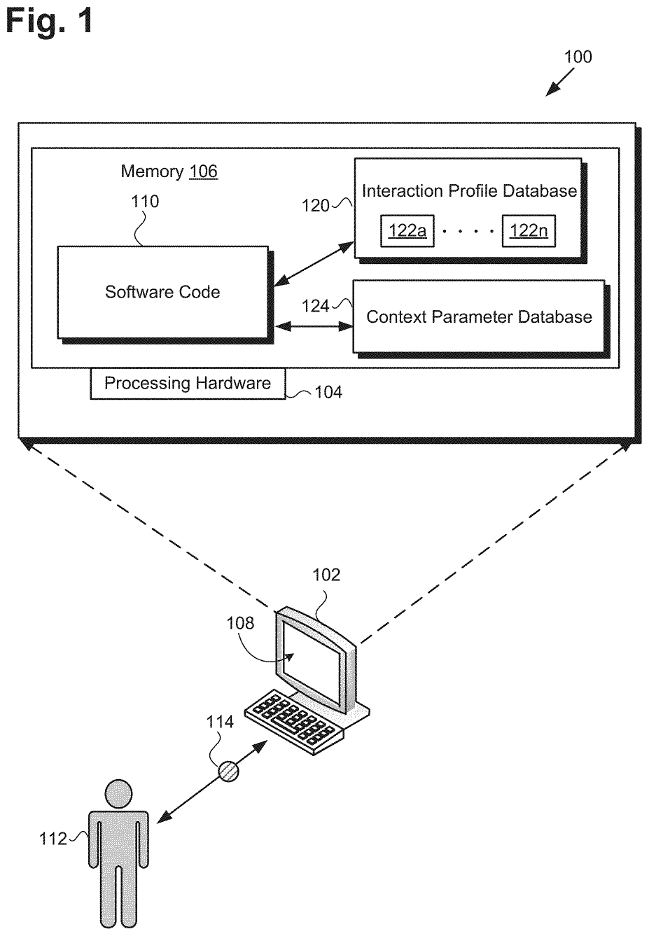

FIG. 1 shows a diagram of system 100 for performing automated multi-persona response generation, according to one exemplary implementation. As shown in FIG. 1, system 100 includes computing platform 102 having processing hardware 104, display 108, and memory 106 implemented as a non-transitory storage medium. According to the present exemplary implementation, memory 106 stores software code 110, interaction profile database 120 including interaction profiles 122a, . . . , 122n (hereinafter “interaction profiles 122a-122n”), and context parameter database 124. In addition. FIG. 1 shows user 112 of system 100 acting as a dialogue author or other programmer of system 100, and input data 114 provided as an input to system 100 by user 112.

Each of interaction profiles 122a-122n may include real or simulated interaction histories of system 100 with a participant or class of participants identified with a particular persona. That is to say, in some implementations, some or all of interaction profiles 122a-122n may be specific to a respective human being, class of human beings, or fictional character, such as a social agent, for example, while in other implementations, some or all of interaction profiles 122a-122n may be dedicated to a particular temporal interaction session or series of temporal interaction sessions including one or more human beings, class of human beings, one or more fictional characters, or a combination thereof. However, it is emphasized that the data describing previous interactions and retained in interaction profile database 120 is exclusive of personally identifiable information (PI) of real human participants, such as test subjects, on which some or all of interaction profiles 122a-122n may be based.

Although the present application refers to software code 110, interaction profile database 120, and context parameter database 124 as being stored in memory 106 for conceptual clarity, more generally, memory 106 may take the form of any computer-readable non-transitory storage medium. The expression “computer-readable non-transitory storage medium,” as defined in the present application, refers to any medium, excluding a carrier wave or other transitory signal that provides instructions to processing hardware 104 of computing platform 102. Thus, a computer-readable non-transitory medium may correspond to various types of media, such as volatile media and non-volatile media, for example. Volatile media may include dynamic memory, such as dynamic random access memory (dynamic RAM), while non-volatile memory may include optical, magnetic, or electrostatic storage devices. Common forms of computer-readable non-transitory storage media include, for example, optical discs. RAM, programmable read-only memory (PROM), erasable PROM (EPROM), and FLASH memory.

Processing hardware 104 may include multiple hardware processing units, such as one or more central processing units, one or more graphics processing units, and one or more tensor processing units, one or more field-programmable gate arrays (FPGAs), custom hardware for machine-learning training or inferencing, and an application programming interface (API) server, for example. By way of definition, as used in the present application, the terms “central processing unit” (CPU), “graphics processing unit” (GPU), and “tensor processing unit” (TPU) have their customary meaning in the art. That is to say, a CPU includes an Arithmetic Logic Unit (ALU) for carrying out the arithmetic and logical operations of computing platform 102, as well as a Control Unit (CU) for retrieving programs, such as software code 110, from memory 106, while a GPU may be implemented to reduce the processing overhead of the CPU by performing computationally intensive graphics or other processing tasks. A TPU is an application-specific integrated circuit (ASIC) configured specifically for artificial intelligence (AI) applications such as machine learning modeling.

It is noted that, as defined in the present application, the expression “machine learning model” may refer to a mathematical model for making future predictions based on patterns learned from samples of data or “training data.” Various learning algorithms can be used to map correlations between input data and output data. These correlations form the mathematical model that can be used to make future predictions on new input data. Such a predictive model may include one or more logistic regression models, Bayesian models, or neural networks (NNs). Moreover, a “deep neural network.” in the context of deep learning, may refer to an NN that utilizes multiple hidden layers between input and output layers, which may allow for learning based on features not explicitly defined in raw data.

It is further noted that, although computing platform 102 is shown as a desktop computer in FIG. 1, that representation is provided merely by way of example. In other implementations, computing platform 102 may take the form of any suitable mobile, stationary, distributed or cloud-based computing device or system that implements data processing capabilities sufficient to provide a user interface and implement the functionality ascribed to system 100 herein. That is to say, in other implementations, computing platform 102 may take the form of a laptop computer, tablet computer, or smartphone, to name a few examples. Moreover, display 108 of system 100 may be implemented as a liquid crystal display (LCD), light-emitting diode (LED) display, organic light-emitting diode (OLED) display, quantum dot (QD) display, or any other suitable display screen that perform a physical transformation of signals to light.

It is noted that, in some implementations, computing platform 102 may correspond to one or more web servers, accessible over a packet-switched network such as the Internet, for example. Alternatively, computing platform 102 may correspond to one or more computer servers supporting a private wide area network (WAN), local area network (LAN), or included in another type of limited distribution or private network. Furthermore, in some implementations, system 100 may be implemented virtually, such as in a data center. For example, in some implementations, system 100 may be implemented in software, or as virtual machines.

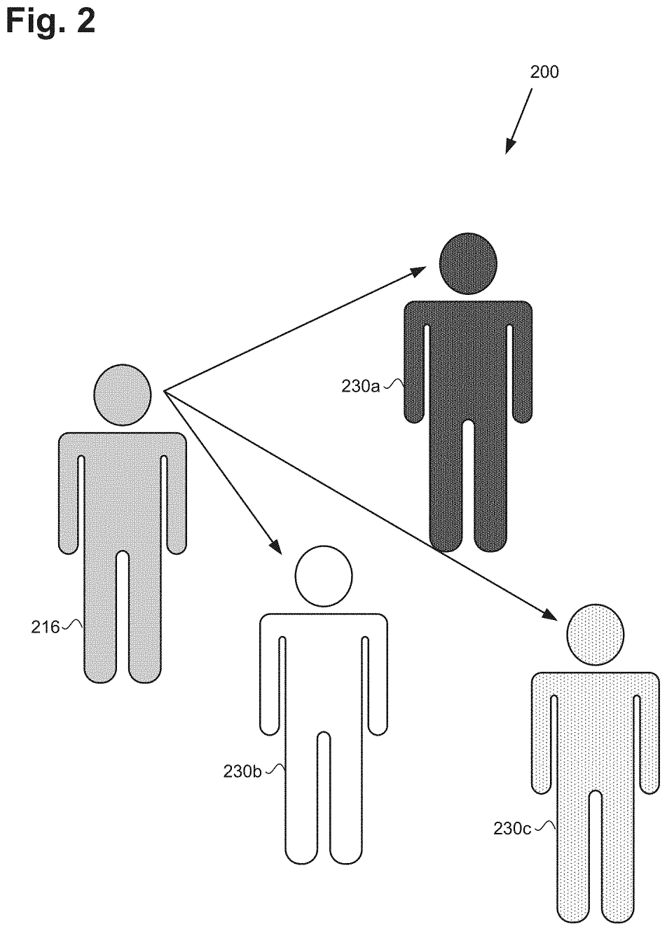

FIG. 2 shows diagram 200 illustrating an exemplary use case for application of automated multi-persona response generation, according to one implementation. FIG. 2 includes social agent 216 communicating with one or more participants 230a, 230b, and 230c. Participants 230a. 230b, and 230c may include human beings, interactive machines instantiating other non-human social agents or fictional characters, or both. According to the exemplary use case shown in FIG. 2, social agent 216 may be programmed, based on the automated multi-persona responses generated by system 100 in FIG. 1, to carry on language-based communication, non-verbal communication, or both, with participants 230a, 230b, and 230c.

In some implementations, each of participants 230a, 230b, and 230c may be associated with a respective one of interaction profiles 122a-122n stored in interaction profile database 120, in FIG. 1. For example, each of participants 230a, 230b, and 230c may have a distinct persona, may have had different interaction histories with social agent 216, different future expectations, or may have different present motivations or be engaged in different activities. Alternatively, in some use cases, participants 230a, 230b, and 230c may belong to a group or class of participants engaged in the same activity, sharing a common present motivation, or otherwise sharing sufficient characteristic to be treated collectively as a single class corresponding to a single interaction profile.

According to the implementation shown in FIG. 2, social agent 216 may initiate an interaction with participants 230a, 230b, and 230c and, based on comparison of a response or responses by one or more of participants 230a, 230b, and 230c with multi-persona responses generated by system 100, may classify participants 230a. 230b, and 230c as individual participants or as members of a participant class. Social agent 216 may then continue the group interaction or individual interactions with participants 230a, 230b, and 230c using the determined participant classification or classifications and the multi-persona responses generated by system 100. According to the exemplary use case shown in FIG. 2, the multi-persona responses generated by system 100 may advantageously be used to enable social agent 216 to engage in relevant and naturalistic interactions with one or more of participants 230a, 230b, and 230c substantially concurrently.

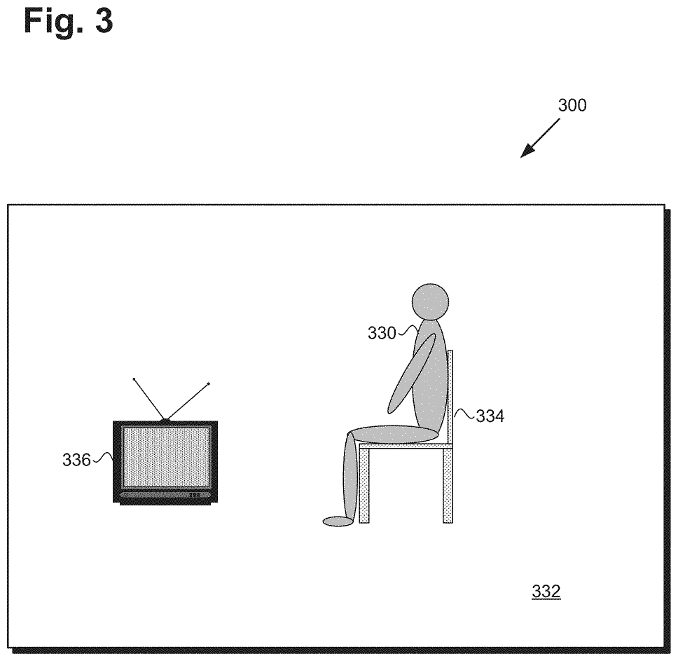

FIG. 3 shows diagram 300 illustrating an exemplary use case for application of automated multi-persona response generation, according to another implementation. FIG. 3 shows participant 330 within venue 332, as well as objects 334 and 336 located in venue 332 and shown as an exemplary chair and television (TV), respectively. In contrast to the use case shown in FIG. 2 and described above, FIG. 3 depicts a use case in which participant 330 does not interact with a social agent. Instead, according to the implementation shown in FIG. 3, participant 330 interacts with one or more of objects 334 and 336 located within venue 332.

By way of example, venue 332 may take the form of a hotel room or cruise ship cabin. The action that is the subject of the multi-persona response generated by system 100, in FIG. 1, may be an event, such as entry of participant 330 into venue 332. Based on an interaction profile of participant 330, it may be anticipated that the response by participant 330 to the action of entering venue 332, for example, will be to seat themselves on chair 334, to turn on or off TV 334, or both. According to the exemplary use case shown in FIG. 3, the multi-persona responses generated by system 100 may advantageously be used to populate and arrange objects within venue 332 that are likely to be desirable to participant 330 when participant 330 is a hotel guest or cruise ship passenger.

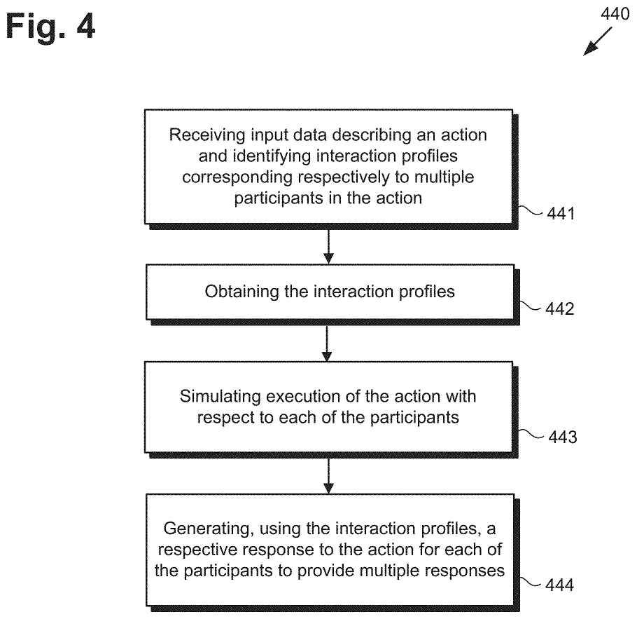

The functionality of software code 110, when executed by processing hardware 104 of system 100, will be further described by reference to FIG. 4. FIG. 4 shows flowchart 440 presenting an exemplary method for performing automated multi-persona response generation, according to one implementation. With respect to the method outlined in FIG. 4, it is noted that certain details and features have been left out of flowchart 440 in order not to obscure the discussion of the inventive features in the present application.

Referring to FIG. 4, with further reference to FIG. 1, flowchart 440 includes receiving input data 114 describing an action and identifying multiple interaction profiles corresponding respectively to multiple participants in the action (action 441). The action described by input data 114 may include one or more of a language-based communication or a non-verbal communication directed to the participants to which the interaction profiles identified in action 441 correspond. For example, the action described by input data 114 may take the form of the same speech directed at each of the participants to which the interaction profiles identified in action 441 correspond.

Alternatively or in addition, in some implementations, the action described by input data 114 may include an event, such as an action performed by each of the participants to which the interaction profiles identified in action 441 correspond. For example, as described above by reference to FIG. 3, in some use cases the action described by input data 114 may take the form of entry into a room, cruise ship cabin, or other venue. Participants to which the interaction profiles identified in action 441 correspond may include human beings, interactive machines instantiating non-human social agents or fictional characters, or any combination thereof. The participants to which the interaction profiles identified in action 441 correspond may include hundreds, thousands, tens of thousands, or hundreds of thousands of participants.

In some implementations, the interaction profiles identified in action 441 may be included among interaction profiles 122a-122n stored in interaction profile database 120. Those interaction profiles may include multiple factors including one or more of personality type or persona, age, gender, ethnicity, spoken language, dialect, and in some implementations, real or simulated previous interactions of the participant with a social agent. Input data 114 may be received in action 441 by software code 110, executed by processing hardware 104 of system 100.

Flowchart 440 further includes obtaining the interaction profiles identified by input data 114 (action 442). Action 442 may be performed by software code 110, executed by processing hardware 104 of system 100. For example, in some implementations, as noted above, the interaction profiles identified in action 441 may be included among interaction profiles 122a-122n stored in interaction profile database 120. In those implementations, the interaction profiles identified by input data 114 may be obtained by importing one or more of interaction profiles 122a-122n stored in interaction profile database 120. Thus, in some implementations, action 442 may be performed by software code 110, executed by processing hardware 104 of system 100, and using interaction profile database 120.

Alternatively, or in addition, in some use cases, processing hardware 104 may execute software code 110 to obtain at least some of the interaction profiles in action 442 by generating those interaction profiles using input data 114. By way of example, where input data 114 ascribes a combination of characteristics to a participant that does not reasonably match an existing one of interaction profiles 122a-122n, software code, when executed by processing hardware 104, may generate a new interaction profile (e.g., interaction profile 122n+1) using that novel combination of characteristics. Subsequent to generating that new interaction profile 122n+1, that new interaction profile may be persistently stored on interaction profile database 120 with interaction profiles 120a-120n.

Flowchart 440 further includes simulating execution of the action described by input data 114 with respect to each of the participants to which the interaction profiles identified in action 441 correspond (action 443). In some implementations, the participants to which the interaction profiles identified in action 441 correspond may include many thousands of participants, which may include one or more of human beings or interactive machines instantiating non-human social agents or fictional characters. Thus action 443 may include simulating the same speech being directed each of those thousands of participants, or may include simulating the same event involving each of those thousands of participants. Action 443 may be performed by software code 110, executed by processing hardware 104 of system 100.

Flowchart 440 further includes generating, using the interaction profiles identified by input data 114, respective responses to the action described by input data 114 for each participant to provide multiple responses (action 444). Action 444 may be performed by software code 110, executed by processing hardware 104 of system 100. In some implementations, action 443 may include simulating the same speech being directed each of thousands of participants. In those implementations, the responses generated in action 444 may include one or more of responsive speech, a gesture, or another action, i.e., a responsive action, by each of those thousands of participants.

However, in other implementations, action 443 may include simulating the same event involving each of those thousands of participants, such as entering a room for example. In those implementations, the responses generated in action 444 may include an action or behavior by each of the thousands of participants, such as sitting down or turning a TV or other device on or off. Software code, when executed by processing hardware 104 of system 100, may be configured to generate the respective responses to the action described by input data 114 for each of the thousands of participants in parallel, thereby providing the responses for all of the participants concurrently.

Moreover, in some use cases input data 114 may further describe a context for the action described by input data 114. Such a context can refer to activities engaged in by a particular participant previous to or concurrently with the action described by input data 114, the goal or motivation of that particular participant, environmental factors such as weather and location, and the subject matter of an ongoing communication with the participant. In implementations in which input data 114 describe the context for the action it also describes, generating the respective responses to the action for each of the participants by software code 110 in action 444 may further use that context for the action.

In some use cases, one or more of the multiple responses provided in action 444 may be used to train an additional AI system, such as a social agent, as defined above. Alternatively, or in addition, in some use cases, one or more of the responses provided in action 444 may be rendered to one or more output devices, such as display 108 of system 100, an audio output device, a robot or other social agent, or any combination thereof.

With respect to the method outlined by flowchart 440, it is emphasized that actions 441 through 444 may be performed in an automated process from which human involvement may be omitted. It is further noted that the novel and inventive concepts disclosed herein are applicable to use cases beyond those described by reference to FIGS. 2 and 3. For example, in some use cases, the present novel and inventive concepts may be advantageously employed to provide a virtual focus group for evaluating the potential popularity of media content, a product, or a service. Alternatively, the present novel and inventive concepts may be used as an aid in compositing an audience for a specific purpose, such as a citizen panel tasked with development or review of public policy initiatives, or as an aide in jury selection, for example.

Thus, the present application discloses systems and methods for performing automated multi-persona response generation. From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A system comprising:
a processing hardware and a memory storing a software code;
the processing hardware configured to execute the software code to:
receive input data describing an action and identifying a plurality of interaction profiles corresponding respectively to a plurality of participants in the action;
obtain the plurality of interaction profiles;
simulate execution of the action with respect to each of the plurality of participants; and
generate, using the plurality of interaction profiles, a respective response to the action for each of the plurality of participants to provide a plurality of responses.

2. The system of claim 1, wherein generating the respective response to the action for each of the plurality of participants is performed in parallel for all of the plurality of participants concurrently.

3. The system of claim 1, wherein the action comprises at least one of a same speech directed at each of the plurality of participants or an event.

4. The system of claim 3, wherein each of the plurality of responses comprises at least one of responsive speech, a gesture, another action, or a respective behavior by each of the plurality of participants.

5. The system of claim 1, wherein at least one of the plurality of responses is used to train an artificial intelligence (AI) system.

6. The system of claim 1, wherein at least one of the plurality of responses is rendered to one or more of a display, an audio output device, or a robot.

7. The system of claim 1, wherein the plurality of participants comprises one or more human beings.

8. The system of claim 1, wherein the plurality of participants comprises one or more fictional characters.

9. The system of claim 1, wherein the processing hardware is further configured to execute the software code to:
obtain at least some of the plurality of interaction profiles by generating, using the input data, the at least some of the plurality of interaction profiles.

10. The system of claim 1, wherein the input data further describes a context for the action, and wherein generating the respective response to the action for each of the plurality of participants further uses the context for the action.

11. A method for use by a system having processing hardware and a memory storing a software code, the method comprising:
receiving, by the software code executed by the processing hardware, input data describing an action and identifying a plurality of interaction profiles corresponding respectively to a plurality of participants in the action;
obtaining, by the software code executed by the processing hardware, the plurality of interaction profiles;
simulating, by the software code executed by the processing hardware, execution of the action with respect to each of the plurality of participants; and
generating, by the software code executed by the processing hardware and using the plurality of interaction profiles, a respective response to the action for each of the plurality of participants to provide a plurality of responses.

12. The method of claim 11, wherein generating the respective response to the action for each of the plurality of participants is performed in parallel for all of the plurality of participants concurrently.

13. The method of claim 11, wherein the action comprises at least one of a same speech directed at each of the plurality of participants or an event.

14. The method of claim 13, wherein each of the plurality of responses comprises at least one of responsive speech, a gesture, another action, or a respective behavior by each of the plurality of participants.

15. The method of claim 11, wherein at least one of the plurality of responses is used to train an artificial intelligence (AI) system.

16. The method of claim 15, wherein at least one of the plurality of responses is rendered to one or more of a display, an audio output device, or a robot.

17. The method of claim 11, wherein the plurality of participants comprises one or more human beings.

18. The method of claim 11, wherein the plurality of participants comprises one or more fictional characters.

19. The method of claim 11, wherein obtaining at least some of the plurality of interaction profiles includes generating, by the software code executed by the processing hardware and using the input data, the at least some of the plurality of interaction profiles.

20. The method of claim 11, wherein the input data further describes a context for the action, and wherein generating the respective response to the action for each of the plurality of participants further uses the context for the action.
